(19) United States
(12) Patent Application Publication
(10) Pub. No.: US 2010/0300693 A1
(43) Pub. Date: Dec. 2, 2010

(54) Enzyme Surfactant Fluids Used in Non-Gel Hydraulic Fracturing of Oil Wells

(76) Inventors: John L. Gray, Houston, TX (US); Allan R. Hartman, Cuero, TX (US); Ronald Michael Herzfeld, Austin, TX (US)

Correspondence Address: GUERRY LEONARD GRUNE, 784 S VILLIER CT., VIRGINIA BEACH, VA, 23452, US

(21) Appl. No.: 12/849,153

(22) Filed: Aug. 3, 2010

Related U.S. Application Data
(63) Continuation-in-part of application No. 11/897,191, filed on Aug. 29, 2007, now abandoned.

(51) Int. Cl. E21B 43/26; C09K 8/62

(52) U.S. Cl. 166/308.1; 507/201

(57) ABSTRACT

The present application describes improved total recovery of oil, condensate and associated gas in a subterranean formation such that said hydrocarbons are released by a hydraulic fracturing process with a non-gel hydraulic fracturing fluid that comprises an enzyme surfactant fluid with at least one anionic surfactant thereby forming a non-gel hydraulic fracturing fluid enzyme surfactant composition which is injected at 1 to 3 percent of total frac fluid during fracturing.

### FIELD OF DISCLOSURE

The present disclosure relates to hydraulic fracturing in a subterranean reservoir and the use of aqueous enzyme surfactant fluids. More specifically, it relates to the addition of enzymes derived from selectively screened and fermented oleophilic or “oil-loving” microbes that are combined with surfactants that target the release of oil from the reservoir structure when hydraulic fracturing oil wells without addition of gels, thickeners, viscosifiers or cross-linked polymer additives.

### BACKGROUND OF DISCLOSURE

Hydrocarbons (oil, natural gas, etc.) are obtained from subterranean geologic formations by drilling a well that penetrates the formation. This provides a partial flow-path for the hydrocarbon to reach the surface. In order for the hydrocarbons to be produced, there must be a sufficiently unimpeded flowpath from the formation to the well bore to be pumped to the surface. Some wells require fracturing due to insufficient porosity or permeability as part of completing the well for initial production. Fracturing a new well provides sufficient channels for oil and gas to flow. In existing wells when the flow of hydrocarbons diminishes, hydraulic fracturing may take place to release more hydrocarbons for recovery.

Hydraulic fracturing is a stimulation treatment routinely performed on oil and gas wells in low-permeability reservoirs. Specially engineered fluids are pumped at high pressure and rate into the reservoir interval to be treated, causing a vertical fracture to open. The wings of the fracture extend away from the wellbore in opposing directions according to the natural stresses within the formation. Proppant, such as grains of sand of a particular size, is mixed with the treatment fluid to keep the fracture open when the treatment is complete. Hydraulic fracturing creates high-conductivity communication with a large area of formation and bypasses any damage that may exist in the near-wellbore area.

Hydraulic fracturing is one of the petroleum (oil and gas) industry's most complex operations. Applied in an effort to increase the well productivity, in a typical procedure, fluids containing propping agents are pumped into a well at high pressures and injection rates high enough to build up sufficient stress to overcome the earth compression stress holding the rock material together. The rock then parts or fractures along a plane perpendicular to the minimum compressive stress in the formation matrix.

Many oil and gas wells require hydraulic fracturing to create channels to allow oil and gas to flow. As defined above, hydraulic fracturing employs fluids that have proppants, such as sand, but also may have gels, thickening agents and/or cross-linked polymers to support the materials within the oil reservoir. The purpose of the additives in the fracturing fluid is to solidify, with an amount of permeability, holding the fissures open to enable the oil to flow more easily from the reservoir material. Oil well depth, geological formation, type of fracturing fluids and other additives in the fracturing procedure, may indicate the need to use significant pressure to fracture the formation and to achieve full infiltration of the fracturing fluid.

Several problems have become associated with such processes, especially with regard to the placement of propping agents in fractures. For example, if too little proppant is used, under infiltration can occur where the fracture is not completely filled with propping agent in the near wellbore region. This greatly reduces productivity due to the closure stresses at the mouth of the fracture near the wellbore. Such problems have been shown to cause the fracture to close upon incomplete fracture fill-up due to the high stress level in the near wellbore region, thereby reducing the effectiveness of the treatment. Similarly, over displacement can occur if too large a volume of propping agent is used, causing proppant to settle in the wellbore itself and cover well perforations, thereby potentially limiting and reducing well productivity.

Another drawback of the fracturing jobs in high permeability formations is that they often result in high skin damage. The skin is the area of the formation adjacent to the bore hole that is often damaged by the invasion of foreign substances, principally fluids, used during drilling and completion operations, including a fracturing treatment. With a guar-base fluid, the “foreign substances” are essentially the polymers or the residues left by the gel breakers, additives developed for reducing the viscosity of the gel at the end of the fracturing treatment by cleaving the polymer into small molecules fragments. These substances create a thin barrier, called a skin, between the wellbore and the reservoir. This barrier causes a pressure drop around the wellbore that is quantified by the skin factor. Skin factor is expressed in dimensionless units: a positive value denotes formation damage; a negative value indicates improvement. Obviously, with the higher concentration of gelling agent, there is a greater the risk of damages and skins. In high permeability formations, this risk is a stronger force increasing the damage by the high proppant concentrations that are often used to obtain wider propped fractures. High skins can also result due to lack of not achieving a tip-screenout (TSO) wherein selected areas of the well are packed to stop fracturing.

After a viscosity fracturing fluid has been pumped into the formation and the fracturing of the formation has been obtained, it is desirable to remove the fluid from the formation to allow hydrocarbon production through the new fractures. Generally, the removal of the viscous fracturing fluid is realized by breaking the gel or emulsion or, in other words, by converting the fracturing fluid into a low viscosity fluid. Breaking the gelled or emulsified fracturing fluid has commonly been obtained by adding a breaker, that is, a viscosity-reducing agent, to the subterranean formation at the desired time. However, known techniques can be unreliable and at times result in incomplete breaking of the fluid and/or premature breaking of the fluid before the fracturing process is complete. Premature breaking can cause a decrease in the number of fractures obtained and thus, the amount of hydrocarbon recovery.

Gels, thickeners or polymers additives that assist in suspension and full infiltration of proppants, can pose a problem producing a phenomenon called “back out” of the formation once they've been fully dispensed. One way operators address this issue is to add encapsulated or liquid enzymes—that are gel, thickener or polymer specific—to degrade the bond in the additives. Petroleum Technology Digest (September 2000) refers to Polymer Specific Enzymes (PSE) that “reduce polymer-related drill-in fluid damage.” Most enzyme use in oilfields is some type of PSE that targets gels, thickeners or polymers additives for drilling mud, breaking up filter cake and for decomposing some type of cellulosic polymer or gel. PSEs are also known as “viscosity breakers”, “visc-breakers” or “breakers.”

The hydraulic fracturing process requires injecting the proppants and additives into the wellbore, pumping out the flowing oil or gas or some combination of hydrocarbon fluids, pumping in additional fluid and additives, such as a PSE to decompose the additives from the first injection and then pumping out the PSE should the need to perform another hydraulic fracturing cycle.

Therefore there is a need for an enzyme surfactant fluid additive to the initial hydraulic fracturing fluid that is oil specific, improves frac fluid and hydrocarbon flowback, and increases the total crude oil, condensate and associated gas recovered from specific oil reservoirs or zones targeted and fractured. There is also a need for enzyme surfactant fluid additives, one of which is TIGERZYME^{R}, which are non-toxic, non-corrosive and biodegradable.

Relevant Art

U.S. Pat. No. 7,213,651, to Brannon, et. al., and assigned to BJ Services, describes a method for fracturing a subterranean formation comprising: introducing a first treatment fluid having a first viscosity and a first density into the subterranean formation; and introducing a second treatment fluid having a second viscosity and a second density into the subterranean formation, wherein at least one of the first treatment fluid and the second treatment fluid comprise a proppant; the first treatment fluid creates a fluid segment extending through the subterranean formation; and the second fluid creates a finger or channel within the fluid.

U.S. Pat. No. 6,981,549, to Morales, et. al., and assigned to Schlumberger Technology Corp., describes a method of designing a hydraulic fracturing treatment in a subterranean reservoir comprising the steps of a) quantifying reservoir parameters including the bottom hole temperature and the formation permeability, b) injecting a calibration fluid, an acid, or any mixtures thereof, c) assessing the temporary variation in temperature of the formation due to the injection prior to a fracturing operation of the calibration fluid, the acid, or any mixtures thereof, and d) designing a treatment fluid optimized for said temporary temperature variation.

U.S. Pat. No. 5,226,479, to Gupta, et. al., and assigned to The Western Company of North America, describes a method of fracturing a subterranean formation comprised of: injecting a fracturing fluid and a breaker system into a formation to be fractured, said breaker system comprised of an enzyme component and γ-butyrolactone; supplying sufficient pressure on the formation for a sufficient period of time to fracture the formation; after fracturing, adjusting the pII of the fluid with γ-butyrolactone whereby the enzyme component becomes active and capable of breaking the fluid; breaking the fluid with the enzyme component; and subsequently releasing the pressure on the formation.

U.S. Pat. No. 4,506,734, to Nolte, Kenneth G., and assigned to The Standard Oil Company, describes a method for reducing the viscosity of a fluid introduced into a subterranean formation, comprising: introducing under pressure a viscosity reducing chemical, contained within hollow or porous, crushable beads, and the fluid into said formation, and reducing said introduction pressure so any resulting fractures in said formation close and crush said beads, whereby the crushing of said beads releases said viscosity reducing chemical.

Chinese Publication No. 1,766,283, to Haifang Ge, and assigned to Dongying Shengshi Petroleum Technology Co. Ltd., describes an oil field oil-water well fracturing craft method of biological enzyme agent, which is characterized by the following: building the mixed biological enzyme agent and water or biological acid or antisludging agent or liquid nitrogen as fracturing fluid; forcing the fracturing fluid into the oil well or water well through the fracturing vehicle; pressing the fracturing fluid into the crack; opening the well after 72 hours. The biological enzyme agent penetrates the hole throat then enters into the microscopic hole gap, which attaches the rock surface and denudes the raw oil to improve the earth penetration factor. The method improves the water wet effect and washes the spalling oil film, which improves the recovery factor of raw oil.

### SUMMARY OF THE DISCLOSURE

One embodiment of the present disclosure includes improved total recovery of crude oil, condensate and associated gas in a subterranean formation wherein these hydrocarbons are releasable by hydraulic fracturing with a non-gel fracturing fluid that comprises an aqueous enzyme surfactant fluid that is normally between 1 to 3 percent concentration of the total frac fluid, thereby forming a hydraulic fracturing enzyme surfactant fluid composition that is then connected to a pressure pump for pumping the hydraulic fracturing fluid composition into a subterranean formation through the oil well that is being hydraulically pressure stimulated. Pumping with sufficient rate and pressure is required to fracture the formation to extend pathways and permeability beyond the near wellbore area establishing greater formation exposure and hydrocarbon recovery range. The enzyme surfactant fluid reduces the surface attraction between the hydrocarbons and the subterranean formation and creates some reduction in oil viscosity, thereby enabling the hydrocarbons to flow back into any fractures created by the hydraulic fracturing process. Flowback to the well of oil, condensate and associated gas from the subterranean formation through the opened fractured zones within the subterranean formation is established as soon as possible by free-flow recovery of the hydrocarbons or by artificial lift pumping methods from the subterranean formation. The hydrocarbons are not “displaced” by non-gel frac fluids being injected nor does non-gel hydraulic fracturing “displace” hydrocarbons by moving fluids from one injection well to one or more producing wells. Using the enzyme surfactant fluid in this type of treatment is not an oil-displacing agent as used in tertiary recovery displacement methods, which includes alkaline surfactant polymer (ASP) floods. Non-gel hydraulic fracturing allows oil, condensate and associated gas to flow by pumping in non-gel fluids and proppants in excess of the downhole fracture gradient thereby creating new pathways, permeability, and extended “reach back” to the wellbore within the zones fractured where pathways, conductivity and permeability were not previously present.

Another embodiment of the present disclosure involves a method for performing hydraulic fracturing in either vertical or horizontal newly drilled or existing producing wells with an application, such as KCl water, produce water, sand, or non-gel fracturing additives that includes enzyme surfactant fluid to target recovery of oil, condensate, and associated gas with a non-gel hydraulic fracture treatment. The specific function of the enzyme surfactant fluid includes reduction of interfacial tension (IFT), improved wettability, and optimized release of oil from solid surfaces with improved mobility.

Another embodiment of the present disclosure is hydraulic fracturing with enzyme surfactant fluid that reduces oil viscosity thru enzymatic activity that catalyzes carbon-nitrogen bonds thus providing better mobility of the oil as well as better relative permeability as oil and gas are produced.

Another embodiment of the present disclosure is a method for performing hydraulic fracturing such that the addition of enzyme surfactant fluid assists with the pumping of the fracturing fluids via a separate frac stage by reducing surface tension and improving effective pumping and displacement of the frac fluid into subterranean formations. Injection is performed on a continuous basis for less than 2 hours per separate frac stage and less than 24 hours total for all separate zones fractured when doing multi-stage fracs. Each individual frac stage is continuous and is performed without interruption or resuming of injection with or without intermittent injection.

Another embodiment of the present disclosure is a method for performing hydraulic fracturing wherein the enzyme surfactant fluid breaks up and mobilizes hydrocarbon deposits that restrict flow of oil and gas to the producing well along the full length of the fractures.

Another embodiment of the present disclosure is a method for performing hydraulic fracturing wherein the enzyme surfactant fluid is injected in a concentration of between 1 and 3 percent of the total non-gel frac fluid being injected while fracturing an oil well.

Another embodiment of the present disclosure is a method for performing hydraulic fracturing wherein the enzyme surfactant fluid is injected at a rate and pressure that is sufficient to fracture the formation.

Another embodiment of the present disclosure is a method for performing hydraulic fracturing such that injecting the enzyme surfactant fluid in a non-gel hydraulic fracture increases initial productivity through less resistance to flow of the oil and gas produced.

Another embodiment of the present disclosure is a method for performing hydraulic fracturing such that injecting enzyme surfactant fluid in a non-gel hydraulic fracture increases the longer-term production and recoverability of a well based on the effectiveness of the frac job performed thus extending the decline curve of a normal well for oil and gas production due to improved mobility of hydrocarbons in the fractures.

Another embodiment of the present disclosure is a method for performing hydraulic fracturing where the enzyme surfactant fluid possesses heat tolerance up to 200 degrees F.

### DESCRIPTION OF THE DRAWING

FIG. 1 is a schematic of the non-gel enzyme surfactant fluid hydraulic fracturing process for a subterranean formation.

### DETAILED DESCRIPTION OF THE DRAWING

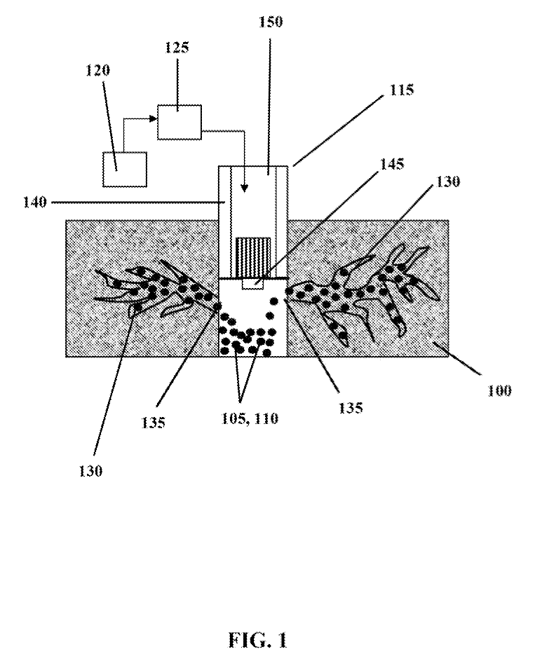

FIG. 1 is a schematic of the non-gel enzyme surfactant fluid hydraulic fracturing process for a subterranean formation [100] that has been producing oil [105] or condensate or associated gas [110] utilizing a production well [115].

The enzyme surfactant enzyme fluid [120] is prepared and pumped into an injection pump [125] when the production well [115] is stopped and sealed off. The injection pump [125] then injects the enzyme surfactant fluid [120] which may contain other non-gel fluids as well as proppants at a rate and hydraulic pressure that is sufficient to fracture the subterranean formation [100], through perforations or open hole sections of the wellbore area [135]. The fractures [130] that are formed by the hydraulic pressure fracturing allow the enzyme surfactant fluid [120] to permeate the fractures [130] and contact the oil [105] or condensate and the subterranean formation [100] composition. The enzyme surfactant fluid [120] reduces the attraction of the oil [105] or condensate [110] to solid surfaces in the subterranean formation [100] allowing the oil [105] or condensate [110] to flow through the fractures [130] toward the wellbore area [135] where the production well [115] flows or pumps the oil [105] or condensate or associated gas [110] to the surface for processing.

An option is to pump the enzyme surfactant enzyme fluid [120] down the casing annulus [140] using the injection pump [125], without the use of a packer [145], having the tubing [150] shut in with fluid loaded to the surface. The fractures [130] that are formed allow the enzyme surfactant fluid [120] to permeate the fractures [130] and contact the oil [105] or condensate [110] in the subterranean formation [100]. After contacting and mobilizing the oil [105] and condensate [110], they are then pumped or flowed up the tubing along with any associated gas [150].

### DETAILED DESCRIPTION

Prior art describes use of specific enzymes as breakers for cross-linked polymers in fracturing fluids to degrade the additive compositions generally used in hydraulic fracturing.
The following is a list of key differentiating characteristics defining an enzyme surfactant fluid, including TIGERZYME®, for enzyme surfactant fluid non-gel hydraulic fracturing:
1. The enzyme surfactant fluid does not contain live microbes or require nutrients.
2. The enzyme surfactant fluid does not chemically degrade oil, but can reduce viscosity by catalyzing breakage of Carbon-Nitrogen bonds thru enzymatic activity.
3. The enzyme surfactant fluid used in non-gel hydraulic fracturing is not designed to target cross-linked polymers.

4. The enzyme surfactant fluid is a combination of enzymes produced by selectively screened oleophilic or “oil-loving” microbes that are combined with surfactants including at least one anionic surfactant.

5. The enzyme surfactant fluid in this process is designed to recover additional oil and condensate along with associated gas thru improved wettability and reduced interfacial tension within created fractures and flowing back thru those fractures.

6. No gels or cross-linked polymers are present in the hydraulic fracture treatment.

7. The enzyme surfactant fluid is non-toxic, non-corrosive and biodegradable.

8. The enzyme surfactant fluid is injected continuously for less than 2 hours via a separate frac stage and in less than 24 hours total for all separate zones fractured when multi-stage fracs are performed. Each individual frac stage is continuous and is performed without interruption or resumption of injection or with intermittent injection.

A hydraulic fracture is formed by pumping a non-gel fracturing fluid with KCl water or produce water and sand into the wellbore at rate sufficient to increase the pressure downhole to a value in excess of the fracture gradient of the formation rock within the reservoir. Injection pressure needed is usually less than the pressure and pumping capabilities typically for a similar well using an admixture of fracturing fluid with a gel proppant additive. In the present disclosure an enzyme surfactant fluid containing at least one anionic surfactant is added to the hydraulic fracturing fluid while pumping and calculated to be 1 to 3 percent of the total frac fluid being pumped. The fluidic pressure then causes the subterranean formation to crack allowing the fracturing fluid with the enzyme surfactant fluid and proppants to enter the crack(s) or fracture(s) thereby propagating into the formation and contacting oil and condensate entrapped within and establishing connectivity for flowing back to the wellbore by keeping said fractures open with the placed proppants.

What is claimed is:

1. A composition for providing improved recovery of crude oil, condensate and associated gas in a subterranean formation wherein oil and/or hydrocarbons are releasable by a hydraulic fracturing process with a non-gel hydraulic fracturing fluid that comprises an aqueous enzyme surfactant fluid, comprising enzymes derived from selectively screened and fermented oleophilic “oil-loving” microbes that are combined with surfactants including at least one anionic surfactant thereby forming a non-gel hydraulic fracturing fluid surfactant enzyme composition that is injected continuously for less than 2 hours during each frac stage and for less than 24 hours total ensuring injection of all separate zones fractured while performing multi-stage fracs.

2. The composition of claim 1, wherein each individual frac stage is continuous and is Performed without interruption or resuming of injection and/or with intermittent injection.

3. The composition of claim 1, wherein said non-gel hydraulic fracturing fluid surfactant enzyme composition is TIGERZYME®.

4. The hydraulic fracturing fluid enzyme surfactant fluid composition of claim 1, wherein said hydrocarbons flow back from said subterranean formation after fracturing is completed and continue flowing through newly created formation fractures that expand conductivity and permeability exposure to the well beyond the near wellbore area and radius and within said subterranean formation, followed by immediate recovery from said subterranean formation of said hydrocarbons by free-flow or artificial lift pumping.

5. The hydraulic fracturing fluid enzyme composition of claim 1, wherein hydraulic fracturing is performed in a vertical or horizontal well with non-gel hydraulic fracturing fluid additives that include said enzyme surfactant fluid, wherein said fluid is non-toxic, non-corrosive, and biodegradable, and wherein said fluid targets oil, condensate, and associated gas within hydrocarbon reservoir areas or zones that are being fractured.

6. The hydraulic fracturing fluid enzyme surfactant fluid composition of claim wherein said enzyme surfactant fluid reduces the viscosity of the oil in the formation by catalyzing breakage of carbon-nitrogen bonds thru enzymatic activity which improves oil mobility and relative permeability thereby improving oil and gas flow.

7. The hydraulic fracturing fluid enzyme composition of claim 1, wherein adding said enzyme surfactant fluid to said non-gel fracturing fluid improves pumping of said non-gel fracturing fluid within fractures and assists in propagation of said hydraulic fracturing fluid with said enzyme surfactant composition throughout said subterranean formation due to reduced interfacial tension and improved wettability.

8. The hydraulic fracturing fluid enzyme composition of claim 1, wherein said enzyme surfactant concentration is between 1 and 3 percent of the total non-gel fracturing fluid being pumped.

9. The non-gel hydraulic fracturing fluid enzyme surfactant composition of claim 8, wherein the total hydraulic non-gel fracturing fluid including said concentration of 1 to 3 percent enzyme surfactant fluid is injected at a rate and pressure sufficient to fracture the formation, but with lower less pressure than required for an hydraulic gel fracture treatment of a similar well.

10. The hydraulic fracturing fluid enzyme surfactant fluid composition of claim 1, wherein the total amount of fluid flows back in an unrestricted manner that begins production of crude oil, condensate and associated gas immediately after fracture pumping has been completed, allowing for free-flowback capture or artificial lift pumping to be established for the well.

11. The hydraulic fracturing fluid enzyme composition of claim 1, wherein the heat tolerance of said enzyme surfactant fluid is at least 200 degrees F. at a pressure greater than atmospheric pressure.

12. A method for providing improved recovery of crude oil, condensate and associated gas in a subterranean formation wherein releasing oil and/or hydrocarbons by a hydraulic fracturing process with a non-gel hydraulic fracturing fluid that comprises an aqueous enzyme surfactant fluid is accomplished, wherein said enzymes are derived from selectively screened and fermented oleophilic “oil-loving” microbes that are combined with surfactants including at least one anionic surfactant thereby forming a non-gel hydraulic fracturing fluid surfactant enzyme composition for continuously injecting for less than 2 hours during each fracing stage and for less than 24 hours total, thereby ensuring injecting of all separate zones fractured while performing multi-stage fracing.

13. The method of claim 12, wherein each individual fracing stage is continuous and is performed without interrupting or resuming of injection and/or with intermittently injecting.

14. The method of claim 12, wherein said non-gel hydraulic fracturing fluid surfactant enzyme composition is TIGERZYME®.

15. The method of claim 12, wherein said hydraulic fracturing fluid enzyme surfactant fluid provides for hydrocarbons flowing back from said subterranean formation after completing fracturing and said fluid continues flowing through newly created formation fractures thereby expanding conductivity and permeability exposure to the well beyond the near wellbore area and radius and within said subterranean formation, followed by immediate recovery from said subterranean formation of said hydrocarbons by free-flow or artificial lift pumping.

16. The method of claim 12, wherein said hydraulic fracturing fluid fracturing is performed in a vertical or horizontal well with non-gel hydraulic fracturing fluid additives that include said enzyme surfactant fluid, wherein said fluid is non-toxic, non-corrosive, and biodegradable, and wherein said fluid targets oil, condensate, and associated gas within hydrocarbon reservoir areas or zones that are being fractured.

17. The method of claim 12, wherein said hydraulic fracturing fluid, wherein said enzyme surfactant fluid reduces the viscosity of the oil in the formation by catalyzing breakage of carbon-nitrogen bonds thru enzymatic activity which improves oil mobility and relative permeability thereby improving oil and gas flow.

18. The method of claim 12, wherein by adding said enzyme surfactant fluid to said non-gel fracturing fluid improves pumping of said non-gel fracturing fluid within fractures thereby assisting in propagating of said hydraulic fracturing fluid with said enzyme surfactant composition throughout said subterranean formation due to reducing interfacial tension and improved wettability.

19. The method of claim 12, wherein said hydraulic fracturing fluid and said enzyme surfactant concentration is between 1 and 3 percent of the total non-gel fracturing fluid being pumped.

20. The method of claim 19, wherein the total hydraulic non-gel fracturing fluid including said concentration of 1 to 3 percent enzyme surfactant fluid is injected at a rate and pressure sufficient to fracture the formation, but with lower less pressure than required for an hydraulic gel fracture treatment of a similar well.

21. The method of claim 12, wherein the total amount of fluid flowing back in an unrestricted manner that begins production of crude oil, condensate and associated gas immediately after fracture pumping has been completed, allowing for free-flowback capture or artificial lift pumping to be established for the well.

22. The method of claim 12, wherein the heat tolerance of said enzyme surfactant fluid is at least 200 degrees F. at a pressure greater. than atmospheric pressure.
